(19) United States
(12) Patent Application Publication
(10) Pub. No.: US 2026/0048307 A1
(43) Pub. Date: Feb. 19, 2026

(54) PICKLEBALL PADDLE WITH IMPROVED CORE

(71) Applicant: Six Zero Pickleball Pty Ltd, Red Hill (AU)

(72) Inventor: Dale Young, Red Hill (AU)

(21) Appl. No.: 19/298,267

(22) Filed: Aug. 13, 2025

(30) Foreign Application Priority Data
Aug. 15, 2024 (AU) 2024902546

(51) Int. Cl. A63B 59/42; A63B 102/08; B32B 3/18; B32B 5/18; B32B 5/24

(52) U.S. Cl. CPC A63B 59/42; B32B 3/18; B32B 5/18; B32B 5/245; A63B 2102/08; A63B 2209/02; B32B 2266/0214; B32B 2307/538

(57) ABSTRACT

A pickleball paddle comprising: a handle; a ball striking blade formed integrally with the handle, the blade being formed from a core layer sandwiched between outer layers to form a unitary body; wherein the core layer comprises a thickness which is substantially greater than thickness of the outer layers, the core layer comprising a plurality of discrete core portions, each of said discrete core portions comprising side walls extending in a direction across the thickness of the core layer, the discrete core portions being arranged to allow respective side walls of adjacent discrete core portions to engage with each other.

### CROSS-REFERENCE TO RELATED APPLICATIONS

This application claims priority to Australian Patent Applications No. 2024902546, filed on Aug. 15, 2024, the contents of which are incorporated herein in its entirety by reference.

### TECHNICAL FIELD

The present invention relates to a pickleball paddle with an improved core and a method of producing a pickleball paddle with an improved core.

### BACKGROUND

Any references to methods, apparatus or documents of the prior art are not to be taken as constituting any evidence or admission that they formed, or form part of the common general knowledge.

Pickleball is one of the fastest growing sports in many parts of the world. Pickleball is played with a flat paddle as opposed to a stringed racket as seen in tennis and badminton. Though the original paddles were cut out of wood by McCallum himself, today's modern versions come in various sizes and thickness levels to accommodate your style of play. The ball used in pickleball is plastic and perforated with anywhere from 26 to 40 holes, similar to a wiffle ball.

Pickleball paddles are usually constructed by cutting or machining a large sheet of material (called a panel) into the shape of a paddle. Another option is moulding foam material into the shape of a paddle. The handle area is then built up with a spacer, upon which grip tape and an end cap are applied. Various types of edge treatments are usually applied around the perimeter of the paddle for a finished look and to provide protection against damage.

It is known that a pickleball paddle usually comprises a striking head or blade, which is generally flat with a rounded contour for striking the ball, and a handle to which the striking head is attached. Typically, the paddle material, striking head and handle contain both a core and a skin. The skin is sometimes called a “laminate” or “face sheet.” When the core material is bonded to the skin material it is usually called a “composite panel” or “sandwich panel.”

A sandwich-structured composite can be a special class of composite materials that may be fabricated by attaching two thin, but stiff, skins to a lightweight, but thick, core. The core material is normally low strength material, but its greater thickness provides the sandwiched composite with both high bending stiffness and low overall density.

Open-cell-structures and closed-cell-structured foams like polyvinylchloride, polyurethane, polyethylene or polystyrene foams, balsa wood, syntactic foams, and honeycombs are commonly used core materials. Open-cell and closed-cell metal foam have been used as core materials.

Laminates of glass or carbon fiber-reinforced thermoplastics or thermoset polymers (unsaturated polyesters, epoxies, and such) are widely used as skin materials. Sheet metal is also used as skin material in some cases.

The core is usually, but not always, made from foam, plastic, aramid, aluminum, honeycomb or a combination thereof. The blade is covered, on at least one side and generally on both sides, with a skin, such as fiberglass, carbon fibre or other suitable thin materials.

One of the problems associated with the blade of the pickleball paddle is that various regions of the core generally provide a similar playing effect. Providing variable impact resistance or reducing impact resistance for the playing surface is desirable.

### SUMMARY OF INVENTION

In an aspect, the invention provides a pickleball paddle comprising:
a handle;
a ball striking blade formed integrally with the handle, the blade being formed from a core layer sandwiched between outer layers to form a unitary body;
wherein the core layer comprises a thickness which is substantially greater than thickness of the outer layers,
the core layer comprising a plurality of discrete core portions, each of said discrete core portions comprising side walls extending in a direction across the thickness of the core layer, the discrete core portions being arranged to allow respective side walls of adjacent discrete core portions to engage with each other.

In an embodiment, the discrete core portions are located within a core frame that forms a peripheral section of the blade.

In an embodiment, the discrete core portions are made from similar materials that have substantially identical materials characteristics.

In an embodiment, the core comprises a plurality of core regions such that discrete portions for each of said plurality of regions have substantially similar material characteristics.

In an embodiment, one or more of core regions provide a corresponding playing effect upon impact by a ball during gameplay.

In an embodiment, the pickleball paddle further comprises fill material between contiguous side walls of adjacently located discrete core portions.

In an embodiment, the side walls of the discrete core portions of the core are arranged to allow limited relative movement between the discrete core portions.

In an embodiment, thickness of the core layer is shaped along a peripheral part of the blade to form an edge extending between the outer layers of the unitary body.

In an embodiment, one or more layers of flexible edge tape being bonded to an outer surface of the edge to at least extend between the outer layers.

In an embodiment, the core is formed from one or more of the following materials: polymeric foam, polypropylene, polyurethane, polyurethane foam, polyester, thermoplastic polyurethane (TPU), Polystyrene Foam, polyamide, other rigid polymer or glass/carbon filled polymer composite, urethane foam, polypropylene, Nomex® polycarbonamide material, ethylene vinyl acetate (EVA), aluminum, balsa, corrugated cardboard, polyethylene, polyvinyl chloride, a polyethylene vinyl acetate, polymethacrylimide, other polymeric foams, other lightweight elastic foams, liquid crystal elastomers (LCE), elastic polymers, liquid crystalline polymers, other types of wood, other metallic alloys, and combinations.

In an alternative embodiment, the discrete core portions may be injection moulded into the core frame to allow the discrete core portions to be moulded between the outer layers.

In an embodiment, at least a portion of the core extends into the handle portion.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is an exploded view of a pickleball paddle 100-1 in accordance with a first embodiment.

FIG. 2 is a frontal view of the pickleball paddle 100-1.

FIG. 3 is an exploded view of the pickleball paddle 100-2 in accordance with a second embodiment.

FIG. 4 is a sectional view of the pickleball paddle 100-2.

FIG. 5 is a plan view of the pickleball paddle.

### DETAILED DESCRIPTION OF PREFERRED EMBODIMENTS

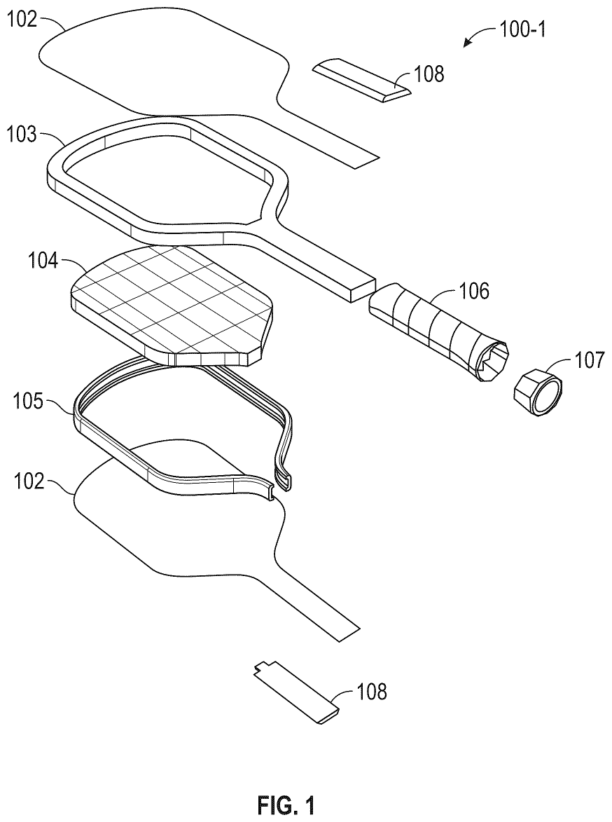

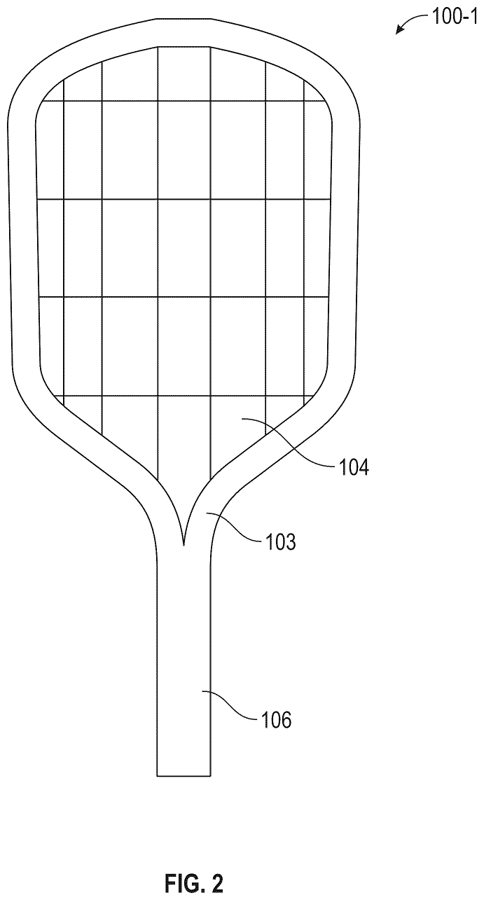

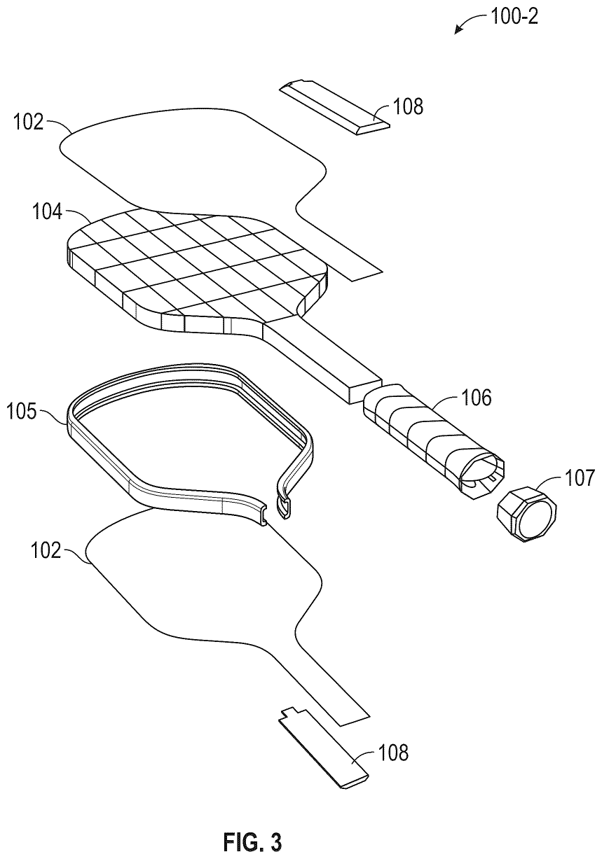

FIGS. 1 and 2 illustrate a first embodiment of a pickleball paddle 100-1 in accordance with a preferred embodiment. FIG. 1 generally illustrates an exploded view of the pickleball paddle 100-1 in accordance with a first embodiment. The pickleball paddle 100 comprises a core 103 that is sandwiched between two outer layers 102 and 107 which form the playing surface for the paddle 100. In the presently described embodiment, the handle and the ball striking blade for the pickleball paddle are integrally formed by the core frame 103 sandwiched between the outer layers 102 and 107. However, the core layer may not be integrally formed with the handle in other embodiments.

The core assembly is made from the core frame 103 with a plurality of discrete core portions 104 that are located within the core frame 103. These discrete core potions 104 effectively comprise top and bottom impact bearing surfaces that extend between side walls that generally extend across the thickness of the core layer. The discrete core portions 104 are arranged in close relationship with one another to allow the side walls of adjoining or adjacent discrete portions 104 to engage with each other to define a notionally suspended core for the paddle 100-1. The side walls of the discrete core portions 104 may be arranged to achieve limited relative movement between the discrete core portions 104. In some instances filler material including but not limited to curable adhesive material may also be introduced in between inter-engaging side walls of the discrete core portions 104.

The inventor believes that providing a core layer with inter-engaging discrete core portions 104 in the presently described embodiment provides several key advantages. It is theorized that impact resistance and flex may be improved or controlled more easily by providing a core that uses discrete and inter-connected core portions 104.

In the presently described embodiment, the handle 105 is integrally formed with the core frame 103.

In the present embodiment, the discrete core portions and the core frame 103 can be made of any one or more of the following: foam, honeycomb, polypropylene, polyurethane, polyurethane foam, polyester, thermoplastic polyurethane (TPU), Thermoplastic Rubber (TPR), Polyether block amide (PEBA), Polystyrene Foam, polyamide, other rigid polymer or glass/carbon filled polymer composite, urethane foam, polypropylene, Nomex® polycarbonamide material, ethylene vinyl acetate (EVA), aluminum, balsa, corrugated cardboard, polyethylene, polyvinyl chloride, a polyethylene vinyl acetate, polymethacrylimide, other polymeric foams, other lightweight elastic foams, liquid crystal elastomers (LCE), elastic polymers, liquid crystalline polymers, other types of wood, other metallic alloys, and combinations thereof.

In some embodiments, a plurality of discrete core portions 104 may comprise a core region that provides specific playing characteristics. In this manner, the playing surface provided by the core may comprises a number of different core regions that can provide a unique set of playing characteristics. Such a variety of playing characteristics may be achieved by ensuring that the discrete core portions 104 for each core region are made from the same material and offer similar material properties. It may also be understood that the materials used for the discrete core portions 104 in one core region may differ from the materials used for the discrete core portions 104 of another region to allow variability of the playing surface offered by the core 103.

The outer layers 102 form face plates of the paddle 100 and may be formed from layers of cross laid unidirectional material, a fiber-composite material, a braided fiber composite material, a woven material, nonwoven fibers embedded in a polymeric matrix, a composite resin-based material, natural fibers, metal, carbon, carbon fiber, glass, fiberglass, graphite, boron, basalt, carrot, Kevlar®, Spectra®, poly-para-phenylene-2, 6-benzobisoxazole (PBO), hemp, Bamboo fiber, polycarbonate, Innegra, Basalt, poly methyl methacrylate, polyamide, polyolefins (e. g, polyethylene), polyurethane, metals, metal alloys and combinations thereof. The playing surface for the outer layers 102 is given a textured finish to impart spin on the ball. A peel ply process may be used to impart the textured finish.

A textured peel ply sheet is applied over a pre-pregnated cloth sheet or multiple layers of cloth sheet. The cloth sheet/s are typically carbon, Kevlar, fiberglass or combinations thereof. In the presently described embodiment, 4 cross-laid sheets per faceplate are being used. In one possible embodiment, 4 sheets of pre-pregnated unidirectional 700K carbon with each sheet laid perpendicular (to the direction of the cloth fibers) to each other may be used. In an alternative embodiment, each outer layer 102 may comprise 2 or more layers of pre-pregnated cross woven fiberglass.

The cloth sheet/s with the applied peel ply may be cured under temperature and pressure on a flatbed (lamination). Additionally, textured paint (grit added to paint to impart texture) and lasered inscription may also be added to the playing surface for the outer layers 102 and 107.

The outer edge for the core frame 103 is shaped to receive an edge tape 105 for protecting the edge of the core frame 103. In a first possible embodiment in which the edge tape 104 may be flush with the respective outer surfaces of the outer layers 102. In a second possible embodiment, the edge tape 104 that laps over peripheral portions of the respective outer surfaces of the outer layers 102.

The detailed manufacturing method will be described in the foregoing sections.

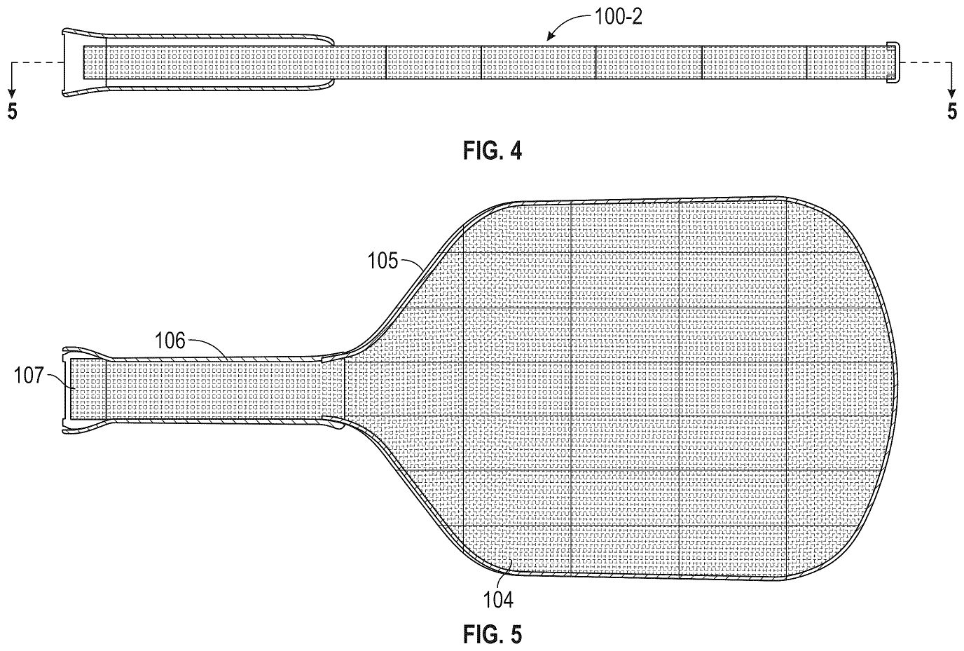

FIGS. 4 and 5 denote a second alternative embodiment of a pickleball paddle 100-2. Like reference numerals denote like features that have been previously discussed in the earlier sections. The main difference between pickleball paddle 100-2 and the previously described paddle 100-1 relates to the core layer. The core layer does not include a core frame and instead only includes discrete core portions 104 which form the entire playing surface for the paddle 100-2. The entire core including the peripheral parts of the core are formed by discrete core portions 104.

Each of these discrete core potions 104 effectively comprise top and bottom impact bearing surfaces that extend between side walls that generally extend across the thickness of the core layer. The discrete core portions 104 are arranged in close relationship with one another to allow the side walls of adjoining or adjacent discrete portions 104 to engage with each other to define a notionally suspended core for the paddle 100-1. The side walls of the discrete core portions 104 may be arranged to achieve limited relative movement between the discrete core portions 104. In some instances filler material including but not limited to curable adhesive material may also be introduced in between inter-engaging side walls of the discrete core portions 104.

Providing the core layer with inter-engaging discrete core portions 104 in the presently described embodiment provides several key advantages. It is theorized that impact resistance and flex may be improved or controlled more easily by providing a core that uses discrete and inter-connected core portions 104.

The absence of the core frame 103 in the second embodiment provides some level of differentiation in the playing characteristics offered by the pickleball paddle 100-2

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A pickleball paddle comprising:
a handle;
a ball striking blade formed integrally with the handle, the blade being formed from a core layer sandwiched between outer layers to form a unitary body;
wherein the core layer comprises a thickness which is substantially greater than thickness of the outer layers,
the core layer comprising a plurality of discrete core portions, each of said discrete core portions comprising side walls extending in a direction across the thickness of the core layer, the discrete core portions being arranged to allow respective side walls of adjacent discrete core portions to engage with each other.

2. A pickleball paddle in accordance with claim 1 wherein the discrete core portions are located within a core frame that forms a peripheral section of the blade.

3. A pickleball paddle in accordance with claim 1 wherein the discrete core portions are made from similar materials that have substantially identical materials characteristics.

4. A pickleball paddle in accordance with claim 1 wherein the core comprises a plurality of core regions such that discrete portions for each of said plurality of regions have substantially similar material characteristics.

5. A pickleball paddle in accordance with claim 4 wherein one or more of core regions provide a corresponding playing effect upon impact by a ball during gameplay.

6. A pickleball paddle in accordance with claim 1 further comprising fill material between contiguous side walls of adjacently located discrete core portions.

7. A pickleball paddle in accordance with claim 1 wherein the side walls of the discrete core portions of the core are arranged to allow limited relative movement between the discrete core portions.

8. A pickleball paddle in accordance with claim 1 wherein thickness of the core layer is shaped along a peripheral part of the blade to form an edge extending between the outer layers of the unitary body.

9. A pickleball paddle in accordance with claim 6 further comprising one or more layers of flexible edge tape being bonded to an outer surface of the edge to at least extend between the outer layers.

10. A pickleball paddle in accordance with claim 1 wherein the core is formed from one or more of the following materials: polymeric foam, polypropylene, polyurethane, polyurethane foam, polyester, thermoplastic polyurethane (TPU), Thermoplastic Rubber (TPR), Polyether block amide (PEBA), Polystyrene Foam, polyamide, other rigid polymer or glass/carbon filled polymer composite, urethane foam, polypropylene, Nomex® polycarbonamide material, ethylene vinyl acetate (EVA), aluminum, balsa, corrugated cardboard, polyethylene, polyvinyl chloride, a polyethylene vinyl acetate, polymethacrylimide, other polymeric foams, other lightweight elastic foams, liquid crystal elastomers (LCE), elastic polymers, liquid crystalline polymers, other types of wood, other metallic alloys, and combinations.

11. A pickleball paddle in accordance with claim 1 wherein the discrete core portions may be injection moulded into the core frame to allow the discrete core portions to be moulded between the outer layers.
